(19) United States
(12) Patent Application Publication
(10) Pub. No.: US 2014/0032436 A1
(43) Pub. Date: Jan. 30, 2014

(54) SYSTEM FOR FACILITATION OF RECRUITMENT OR HIRING ON AN ONLINE INTERFACE AND METHODS THEREOF

(71) Applicant: DHRUV PRAVIN PATEL, MUMBAI (IN)

(72) Inventor: DHRUV PRAVIN PATEL, MUMBAI (IN)

(21) Appl. No.: 13/897,464

(22) Filed: May 20, 2013

(30) Foreign Application Priority Data
Jun. 29, 2012 (IN) 1882/MUM/2012

(51) Int. Cl. G06Q 10/10

(52) U.S. Cl. CPC G06Q 10/1053
USPC 705/321

(57) ABSTRACT

The present invention in a preferred embodiment provides systems and methods for facilitation of recruitment or hiring on an online interface which provide the employer with the “jobseekers' search list” based on a predefined questionnaire or custom questionnaire comprising of direct questions or queries or multiple choice options, whereby any descriptive or elaborate answers or details are eliminated. Jobseekers' attributes are matched with employers' desired job attributes based on the predefined questionnaire or custom questionnaires. Matching of the attributes generates scores or ranks depending on a pre-defined system and weightage provided to specific job attributes.

### FIELD OF THE INVENTION

The present invention relate's to the field of recruitment or hiring on an online interface and methods thereof. More specifically the present invention relates to a match-based employment system wherein the employer is provided with the “jobseekers' list” based on a predefined questionnaire or custom questionnaire comprising of objective and non-descriptive questions or multiple choice options.

### BACKGROUND OF THE INVENTION

In the present era, there are many employment websites or job portals that are designed to enable a central forum for effective employment and hiring, wherein employers may post job requirements for an employment position to reach out to prospective employees or jobseekers, and wherein the employers also have the provision to search across a large number of jobseekers' profiles to find the appropriate jobseeker for employment. These websites also offer employer reviews, career and job-search advice describe different job descriptions or employers. Through a job portal, a jobseeker or a prospective employee can locate and fill out a job application or submit their profile details or resumes over an online interface. This system has, to a great extent, facilitated the process of hiring an employee or seeking a job in the present age.

However, while using the present systems and methods involving job portals, employers often have difficulty in locating and identifying a relevant jobseeker by searching resumes on the job portal due to the current practices of information presented and profile matching such as but not limited to:
the description of certain attribute by a jobseeker may be vague, incomplete, inadequate or too generic;
the variation in the format or construction of sentences or search keywords provided by a jobseeker and other such reasons lead to irrelevant results. A jobseeker may sometimes miss or forget to include a certain keyword or synonym keywords or complete information in his or her profile and thus an employer may lose the eligible jobseeker as the indicators or parameters chosen by both parties with respect of keywords did not match even though the expertise required would have matched.

Such instances would thus make the purpose of a job portal redundant, due to low relevancy and low hit rate which will also end up wasting the potential time of the employer and jobseeker.

Already known recruitment or hiring online interfaces comprise questionnaires that contain questions related to jobseekers' education, career history, skills, uploaded resume and contact information which gives information about the jobseeker including objective and descriptive information, whereby the descriptive information gives a huge scope of variation and interpretation allowing inconsistent and irrelevant matching of attributes.

The present invention in its various embodiments addresses the above and other possible drawbacks and limitations of the currently used systems and methods relating to the field of invention by providing the employer and jobseeker with much more relevant and accurate matching, and also provides an option of obtaining a “jobseekers list” based on the predefined questionnaire or custom questionnaire comprising of direct questions or queries or multiple choice options which are objective, whereby any descriptive or elaborate answers or details are eliminated. Jobseekers' attributes are matched with employers' desired job attributes based on the questionnaires. Matching of the attributes generates the scores depending on a pre-defined system and weightage provided to specific job attributes. Thus, the relevant list of the jobseekers is generated and sorted according to the scores calculated.

### SUMMARY OF THE INVENTION

The present invention in a preferred embodiment provides systems and methods for facilitation of recruitment or hiring on an online interface which provide the employer with the “jobseekers' search list” based on a predefined questionnaire or custom questionnaire comprising of direct questions or queries or multiple choice options, whereby any descriptive or elaborate answers or details are eliminated. Jobseekers' attributes are matched with employers' desired job attributes based on the predefined questionnaire or custom questionnaires. Matching of the attributes generates scores or ranks depending on a pre-defined system and weightage provided to specific job attributes.

The present invention in a preferred embodiment provides systems for facilitation of recruitment or hiring on an online interface, wherein the system comprises:
a. at least one profile database capable of comprising at least one jobseeker profile, wherein the at least one jobseeker profile comprises of at least one Jobseeker's attribute;
b. at least one profile creation interface;
c. at least one employer request interface capable of allowing an employer to submit a request of at least one employer's desired job attribute;
d. at least one questionnaire database;
e. at least one matching interface;
f. at least one score generation or ranking interface;
g. at least one report generation interface capable of a generating a job match report; and
h. at least one graphical user interface capable of being accessed by a jobseeker or an employer;
   wherein the at least one questionnaire database comprises at least one predefined questionnaire comprising non-descriptive questions or multiple choice options whereby descriptive answers are eliminated; and
   wherein a jobseeker is capable of creating a profile using at least one profile creation interface, with profile attributes by providing answers to non-descriptive questions or multiple choice options of the at least one predefined questionnaire, whereby the profile is stored in the at least one profile database; and
   wherein an employer is capable of identifying or searching a desired jobseeker by submitting a request of at least one employer's desired job attribute on the at least one employer request interface; and
   wherein at least one matching interface is capable of matching at least one Jobseeker's attribute and at least one employer's desired job attribute;
   wherein the at least one score generation or ranking interface generates a score or a rank or a combination of both score and rank based on a predefined algorithm, wherein the predefined algorithm uses a weightage provided to Jobseeker's attribute which has been matched by the at least one matching interface; and
   and wherein the at least one report generation interface generates the job match report based on the score or the rank or the combination of both score and rank generated by the at least one score generation or ranking interface.

The present invention in a preferred embodiment provides a computer network implemented method for facilitation of recruitment or hiring on an online interface, wherein the method comprises the steps of:
a. storing a predefined questionnaire comprising non-descriptive questions or multiple choice options in at least one questionnaire database;
b. creating a profile with profile attributes by a jobseeker using at least one profile creation interface, with profile attributes by providing answers to non-descriptive questions or multiple choice options of the at least one predefined questionnaire;
c. storing the profile in at least one profile database;
d. submitting a request of at least one employer's desired job attribute on the at least one employer request interface for identifying or searching a desired jobseeker by an employer;
e. matching at least one Jobseeker's attribute and at least one employer's desired job attribute by at least one matching interface;
f. generating a score or a rank or a combination of both score and rank based on a predefined algorithm by at least one score generation or ranking interface, wherein the predefined algorithm uses a weightage provided to Jobseeker's attribute which has been matched by the at least one matching interface; and
g. generating a job match report by at least one report generation interface based on the score or the rank or the combination of both score and rank generated by the at least one score generation or ranking interface.

### BRIEF DESCRIPTION OF THE ACCOMPANYING DIAGRAMS

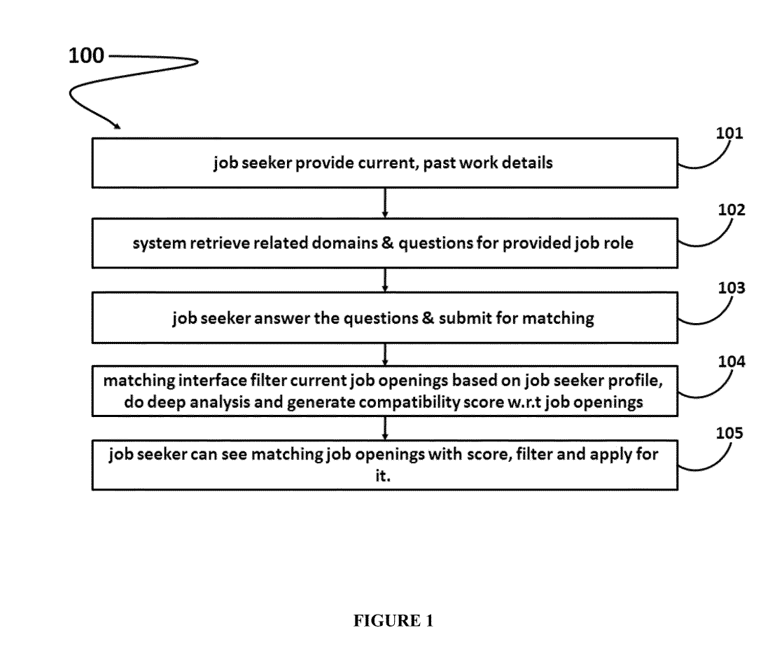

FIG. 1 is a flowchart representing an example of one of the embodiments of the invention.

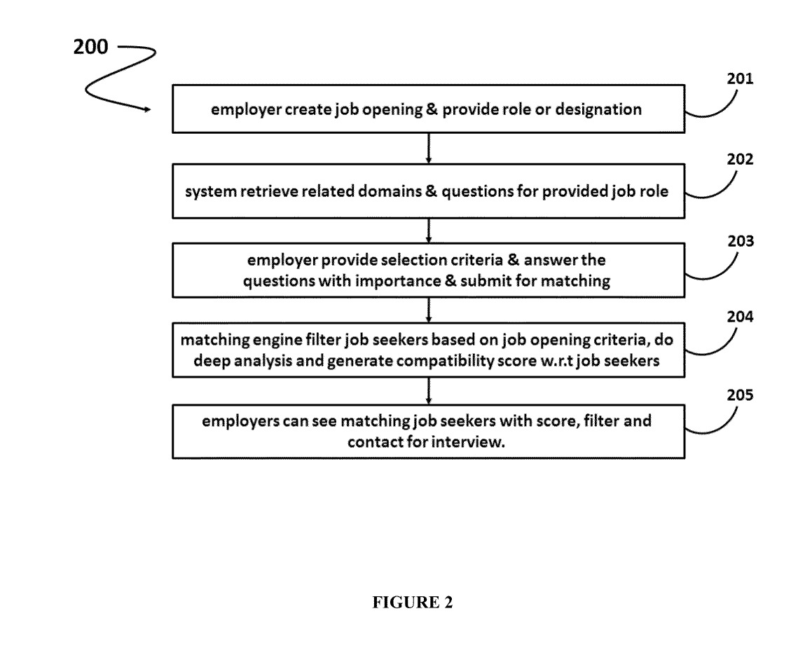

FIG. 2 is a flowchart representing an example of another embodiment of the invention.

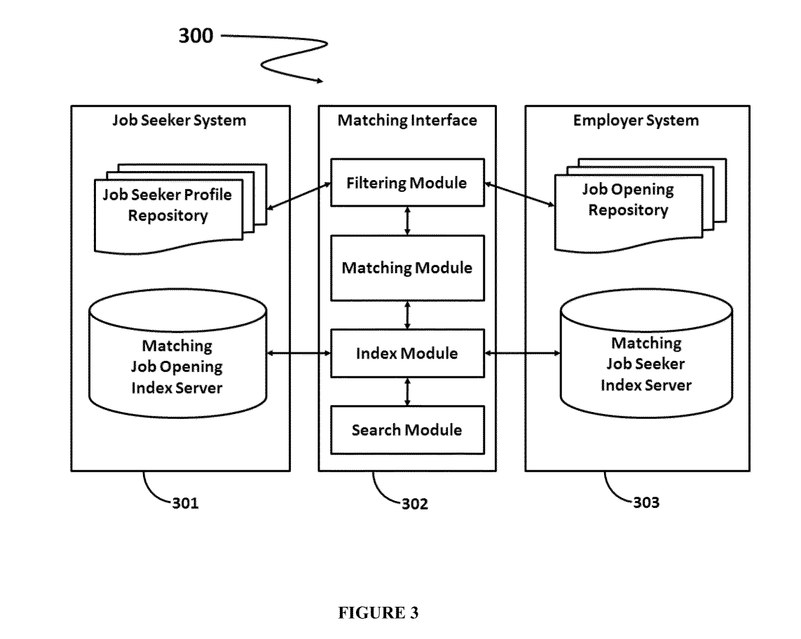

FIG. 3 is a flowchart representing an example of yet another embodiment of the invention.

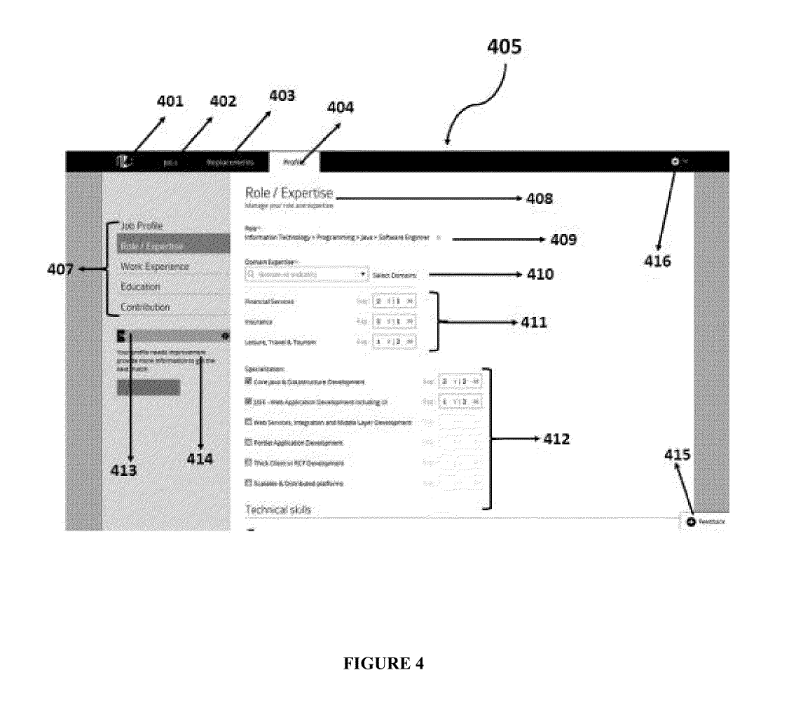

FIG. 4 is a diagrammatic representation of an example of one of the embodiments of the invention.

### DETAILED DESCRIPTION OF THE INVENTION

The present invention in a preferred embodiment provides systems and methods for facilitation of recruitment or hiring on an online interface which provide the employer with the “jobseekers' search list” based on a predefined questionnaire or custom questionnaire comprising of direct questions or queries or multiple choice options, whereby any descriptive or elaborate answers or details are eliminated. Jobseekers' attributes are matched with employers' desired job attributes based on the predefined questionnaire or custom questionnaires. Matching of the attributes generates scores or ranks depending on a pre-defined system and weightage provided to specific job attributes.

The present invention in a preferred embodiment provides systems for facilitation of recruitment or hiring on an online interface, wherein the system comprises:
a. at least one profile database capable of comprising at least one jobseeker profile, wherein the at least one jobseeker profile comprises of at least one Jobseeker's attribute;
b. at least one profile creation interface;
c. at least one employer request interface capable of allowing an employer to submit a request of at least one employer's desired job attribute;
d. at least one questionnaire database;
e. at least one matching interface;
f. at least one score generation or ranking interface;
g. at least one report generation interface capable of a generating a job match report; and
h. at least one graphical user interface capable of being accessed by a jobseeker or an employer;
   wherein the at least one questionnaire database comprises at least one predefined questionnaire comprising non-descriptive questions or multiple choice options whereby descriptive answers are eliminated; and
   wherein a jobseeker is capable of creating a profile using at least one profile creation interface, with profile attributes by providing answers to non-descriptive questions or multiple choice options of the at least one predefined questionnaire, whereby the profile is stored in the at least one profile database; and
   wherein an employer is capable of identifying or searching a desired jobseeker by submitting a request of at least one employer's desired job attribute on the at least one employer request interface; and
   wherein at least one matching interface is capable of matching at least one Jobseeker's attribute and at least one employer's desired job attribute;
   wherein the at least one score generation or ranking interface generates a score or a rank or a combination of both score and rank based on a predefined algorithm, wherein the predefined algorithm uses a weightage provided to Jobseeker's attribute which has been matched by the at least one matching interface; and
   and wherein the at least one report generation interface generates the job match report based on the score or the rank or the combination of both score and rank generated by the at least one score generation or ranking interface.

The present invention in a preferred embodiment provides a computer network implemented method for facilitation of recruitment or hiring on an online interface, wherein the method comprises the steps of:
a. storing a predefined questionnaire comprising non-descriptive questions or multiple choice options in at least one questionnaire database;
b. creating a profile with profile attributes by a jobseeker using at least one profile creation interface, with profile attributes by providing answers to non-descriptive questions or multiple choice options of the at least one predefined questionnaire;
c. storing the profile in at least one profile database;
d. submitting a request of at least one employer's desired job attribute on the at least one employer request interface for identifying or searching a desired jobseeker by an employer;
e. matching at least one Jobseeker's attribute and at least one employer's desired job attribute by at least one matching interface;
f. generating a score or a rank or a combination of both score and rank based on a predefined algorithm by at least one score generation or ranking interface, wherein the predefined algorithm uses a weightage provided to Jobseeker's attribute which has been matched by the at least one matching interface; and
g. generating a job match report by at least one report generation interface based on the score or the rank or the combination of both score and rank generated by the at least one score generation or ranking interface.

The present invention in yet another a preferred embodiment provides a computer program product for facilitation of recruitment or hiring on an online interface, the computer program product embodied in a computer readable medium that, when executing on a computer, performs steps comprising:
a. storing a predefined questionnaire comprising non-descriptive questions or multiple choice options in at least one questionnaire database;
b. creating a profile with profile attributes by a jobseeker using at least one profile creation interface, with profile attributes by providing answers to non-descriptive questions or multiple choice options of the at least one predefined questionnaire;
c. storing the profile in at least one profile database;
d. submitting a request of at least one employer's desired job attribute on the at least one employer request interface for identifying or searching a desired jobseeker by an employer;
e. matching at least one Jobseeker's attribute and at least one employer's desired job attribute by at least one matching interface;
f. generating a score or a rank or a combination of both score and rank based on a predefined algorithm by at least one score generation or ranking interface, wherein the predefined algorithm uses a weightage provided to Jobseeker's attribute which has been matched by the at least one matching interface; and
g. generating a job match report by at least one report generation interface based on the score or the rank or the combination of both score and rank generated by the at least one score generation or ranking interface.

In an embodiment of the invention, the system further comprises of at least one authentication interface capable of authenticating a jobseeker or an employer.

In an embodiment of the invention, the authentication interface comprises of a data storage component capable of storing the identity of a jobseeker or an employer, which may be linked to an authenticating code such as a password. The authentication interface further comprises of a mechanism to match the identity of a jobseeker or an employer on each instance when a request for authentication is made. The authentication interface further comprises of a mechanism to allow or deny access of the system to a user requesting authentication, wherein said request may be made by entering a username in combination with a password in a data entry field on the graphical user interface.

In an embodiment of the invention, the method for facilitation of recruitment or hiring on an online interface further comprises the step of authenticating a jobseeker or an employer by at least one authentication interface.

In an embodiment of the invention, the method for facilitation of recruitment or hiring on an online interface further comprises the step of creating a job posting which is stored in at least one job posting database, wherein said step of creating is done by at least one job posting creation interface.

In an embodiment of the invention, the authentication interface allows the step of signing up or logging into a website or a job portal of the present invention.

In an embodiment of the invention, the system further comprises of at least one job posting creation interface using which an employer may create a job posting which is stored in at least one job posting database.

In an embodiment of the invention, the system further comprises of a search interface for a jobseeker using which the jobseeker may search one or more job postings on the at least one job posting database.

In an embodiment of the invention, the system further comprises of a search interface for an employer using which an employer may search one or more profiles stored in the at least one profile database.

In an embodiment of the invention, the system further comprises of at least one modification interface capable of allowing a jobseeker to modify or edit at least an attribute of a profile and allowing an employer to modify or edit at least an employer's desired job attribute.

In an embodiment of the invention, the system further comprises of a chat interface allowing a user to interact with another user or a helpline executive.

In an embodiment of the invention, the system further comprises of a chat interface allowing a user to send offline messages to another user or a helpline executive.

In an embodiment of the invention, the system further comprises of a feedback mechanism using which a jobseeker or an employer may submit a feedback.

In an embodiment of the invention, the system further comprises of a virtual region on the graphical user interface allowing the display of an advertisement.

In an embodiment of the invention, the system further comprises of an interface allowing the execution of a multimedia file such as but not limited to music or a video or a cinematographic work or a combination thereof.

In an embodiment of the invention, the at least one predefined questionnaire may be different for different industries.

In an embodiment of the invention, the at least one predefined questionnaire comprising non-descriptive questions or multiple choice options may have one or more questions associated with another question of at least one predefined questionnaire such that if one question is answered with a specific answer than another question shall be asked based on the answer of the previous question.

In an embodiment of the invention, the profile attributes may be different for different industries.

In an embodiment of the invention, the at least one predefined questionnaire may be predefined by an employer.

In an embodiment of the invention, the at least one predefined questionnaire may be predefined by the system or in the system.

In an embodiment of the invention, the system further comprises of an account creation interface, which allows a specific identity linked account to be created when an employer or a jobseeker registers with the system using an account registration interface, and allows an employer or a jobseeker access their specific identity linked account on authentication by the authentication interface.

In an embodiment of the invention, searches carried out by an employer can be saved by an employer or a jobseeker indexed to their specific identity linked account.

In an embodiment of the invention, a jobseeker is allowed to upload a file in association to the jobseeker's profile. In an embodiment of the invention, the file may be a text file, a multimedia file or a combination thereof.

In an embodiment of the invention, a jobseeker is allowed to upload a photograph depicting the visual appearance of the face of the jobseeker, in association to the jobseeker's profile.

In an embodiment of the invention, a jobseeker is allowed to upload a copy of marksheet or professional certificate or academic certificate or extra-curricular certificate, in association to the jobseeker's profile.

In an embodiment of the invention, a jobseeker is allowed to upload a recommendation letter or a character certificate or a moral certificate, in association to the jobseeker's profile.

In an embodiment of the invention, the system further comprises of an alert mechanism which is capable of communicating information to a jobseeker or an employer in the form of an alert to an electronic device accessible by the jobseeker or the employer.

In an embodiment of the invention, the predefined algorithm may be modified by an employer.

In an embodiment of the invention, the weightage may be modified by an employer.

In an embodiment of the invention, the job match report is a ‘job seekers list’ for an employer

In an embodiment of the invention, the job match report is a ‘matching job list’ for a jobseeker

In an embodiment of the invention, the job match report may comprise of graphs.

In an embodiment of the invention, the job match report may comprise of charts.

In an embodiment of the invention, the job match report may comprise of images.

In an embodiment of the invention, the job match report may comprise of embedded files.

In an embodiment of the invention, the job match report may comprise of geographical maps.

In an embodiment of the invention, the job match report is capable of being downloaded in a computer enabled executable or operable file.

In an embodiment of the invention, the job match report is capable of being saved by an employer or a jobseeker indexed to their specific identity linked account.

In an embodiment of the invention, the system may further comprise of an ecommerce system.

In an embodiment of the invention, the system may further comprise of language translation tool.

In an embodiment of the invention, the system may further comprise of a tool to count the number of different jobseekers that access a specific job posting.

In an embodiment of the invention, the system may further comprise of a tool to count the number of different employers that access a specific profile.

In an embodiment of the invention, the system may further comprise of a tool to monitor the activity of a jobseeker or an employer.

In an embodiment of the invention, may comprise of language translation tool.

In an embodiment of the invention, the Graphical user interface (GUI) allows a user to view one or more aspects or features of the present system, and allows a user to interact with the one or more aspects or features of the present system or input data in one or more data fields or click on hyperlinks.

The present invention in an embodiment provides system and methods for facilitation of recruitment or hiring on an online interface that provides job criteria such as but not limited to a role hierarchy, a specialization and a specific attribute, each of which may be collected or submitted through a questionnaire provided to a jobseeker or an employer for a specific type of job. A specific attribute may be such as but not limited to a set of age, sex, date of birth, location, educational qualification, years of experience, languages know, computer programs known, salary, father's occupation, mother's occupation, brother's occupation, sister's occupation, current employer, previous employer, percentage of marks, name of educational institution, extracurricular interest, passport validation details, PAN card validation details, identity card details, recommendation details, recommender's details, job title, VISA details, health status details or any combination thereof.

In an embodiment of the invention, profiles of the jobseekers are differentiated based on attributes.

In an embodiment of the invention, a role hierarchy may comprise of a single level and multiple levels.

In an embodiment of the invention, a specialization may comprise of a single level and multiple levels.

In an embodiment of the invention, attributes may be further categorised under attribute categories.

In an embodiment of the invention an attribute category may be capable of acting as a single attribute.

In an embodiment of the invention, different user interfaces may be provided to a jobseeker and an employer.

In an embodiment of the invention, a jobseeker or an employer is redirected to a dashboard after the authentication of their identity, wherein the jobseeker or the employer can manage their details and association with the job portals such as but not limited to account details, payment schemes, privacy settings, bibliographic information or any combination thereof.

In an embodiment of the invention, an employer is provided access to profiles of jobseekers, either directly or through a search interface, which may allow the employer to select different attributes, hierarchical roles, specializations or combinations thereof to view or search the corresponding jobseekers profiles.

In an embodiment of the invention, a method by which a jobseeker finds matching jobs and similar jobseekers comprises steps of
a. signing up or logging into a website or a job portal;
b. redirecting to a dashboard, wherein the jobseeker can edit a profile or attributes related to the profile;
c. submitting the edited profile or the attributes for the process of matching; and
d. viewing matching jobs and similar jobseekers along with a score.

In an embodiment of the invention, a method by which an employer finds matching jobseekers comprises steps of

a. signing up or logging into a website or a job portal;
b. redirecting to a dashboard, wherein the employer can edit a job post or attributes in the job post;
c. submitting the edited post or attributes for the process of matching;
d. viewing matching jobseekers along with a score; and
e. editing the post or changing the attributes to filter the results obtained in the previous step.

In an embodiment of the invention, the terms graphical user interface and dashboard may be alternately used for the purpose of this invention.

In an embodiment of the invention, the terms jobseeker and candidate may be alternately used for the purpose of this invention.

In an embodiment of the invention, the terms job posting and job opening may be alternately used for the purpose of this invention.

In an embodiment of the invention, a matching engine is used to match a set of one or more attributes corresponding to a jobseeker's profile.

In an embodiment of the invention, a scoring engine is used to provide a score to one or more jobseekers associated with the job portal.

The present invention in yet another preferred embodiment provides method for facilitation of recruitment or hiring on an online interface, wherein the method comprises:
a. authenticating a user entry to a system by at least one authentication interface based on user details available in at least one profile database, wherein a user is a jobseeker or an employer and;
b. redirecting the user to at least one dashboard;
c. editing the profile or the attributes related to the profile through at least one modification interface;
d. submitting a query by the user through at least one submission interface, wherein the query is based on a. custom questionnaire or a predefined questionnaire selected from at least one questionnaire database, wherein the predefined questionnaire or the custom questionnaire comprise of questions selected from the group of direct questions or queries or multiple choice options or combinations thereof, whereby any descriptive or elaborate answers or details are eliminated;
e. matching attributes of profiles with attributes of desired profiles stored in the at least one attribute database by at least one matching interface;
f. generating scores based on the matching of the attributes of the profiles and desired attributes by at least one score generation interface;
g. ranking of profiles based on scores generated by at least one ranking; and
h. providing the employer with a search list comprising of jobseekers' profiles matching the desired attributes and similar jobs, and/or the jobseeker with a search list comprising of similar jobseekers and matching jobs, by at least one report generation interface.

In another embodiment of the invention method for facilitation of recruitment or hiring on an online interface further comprises the step of editing the query or changing the attributes to filter the search list obtained in the previous step.

Another preferred embodiment of the invention provides a computer program product for facilitation of recruitment or hiring on an online interface, wherein the computer program product comprises:
a. at least one authentication interface;
b. at least one dashboard;
c. at least one modification interface;
d. at least one submission interface;
e. at least one matching interface;
f. at least one score generation interface;
g. at least one ranking interface;
h. at least one report generation interface;
i. at least one profile database;
j. at least one attribute database; and
k. at least one questionnaire database;
   wherein the at least one authentication interface is capable of authenticating a user entry to the system based on user details available in the at least one profile database; and
   wherein a user is a jobseeker or an employer; and
   wherein a user is redirected to the at least one dashboard; and
   wherein the at least one modification interface is capable of allowing the user to edit a attributes of profile if the user is the jobseeker and desired attributes if the user is employer, through the at least one dashboard; and
   wherein the at least one submission interface is capable of submitting a query by the user; and
   wherein the query is based on a custom questionnaire or a predefined questionnaire selected from the at least one questionnaire database; and
   wherein the predefined questionnaire or the custom questionnaire comprise of questions selected from the group of direct questions or queries or multiple choice options or combinations thereof, whereby any descriptive or elaborate answers or details are eliminated; and
   wherein the at least one matching interface is capable of matching attributes of profiles with attributes of desired profiles stored in the at least one attribute database; and
   wherein the at least one score generation interface is capable of generating scores based on the matching of the attributes of the profiles and desired attributes; and
   wherein the at least one ranking interface is capable of is capable of ranking profiles based on scores generated; and
   wherein the at least one report generation interface is capable of providing the employer with a search list comprising of jobseekers' profiles matching the desired attributes and similar jobs, and/or the jobseeker with a search list comprising of similar jobseekers and matching jobs.

In an embodiment of the invention, system and methods for facilitation of recruitment or hiring on an online interface may be accessed through any suitable electronic medium which are either already in use or may be developed in future such as but not limited to a computer, mobiles phones, tablets, smart phones, laptops, notebooks, touchpads or any combination thereof.

In an embodiment of the invention, system and methods for facilitation of recruitment or hiring on an online interface may be accessed through electronic communication medium which are either already in use or may be developed in future such as but not limited to SMS, email, social media notification, iTunes application, Android application, Symbian application, Blackberry application or any combination thereof.

In an embodiment of the invention, a computer program product residing on a machine readable medium may provide or enable access to a system for recruitment or hiring on an online interface, wherein the computer program product is tangibly stored on machine readable media.

In an embodiment of the invention, it may be required that the electronic device be registered or indexed with the encryption and identification program. As an addition or alteration to this embodiment, it may be required that the electronic device may meet certain predetermined parameters such as but not limited to having licensed version of software or operating system of the device, or an original device itself.

In an embodiment of the invention, information used for the purpose of this invention may be partially or entirely virtual data.

The term virtual data shall include any data or information or program or software or code which can be stored or accessible or convertible in an electronic format.

Any user may be involved in the systems and methods of the present invention as an employer or a jobseeker, wherein user is any person, machine or software that uses or accesses one or more of the systems or methods of the present invention. A user includes an automated computer program and a robot.

The terms attribute or attributes or “attribute of specializations” for the purpose of this invention means the physical or intellectual characteristic or quality of a jobseeker or a desired candidate, wherein the physical or intellectual quality can be any suitable quality such as but not limited to height, weight, BMI, educational qualification, age, work experience, skills, specialization, computer based skills, hobbies, interests, activities involved, awards, marital status, location, languages known or any combination thereof

The term job for the purpose of this invention means the specific opportunity provided to a person in which the person enters in a state of employment of any nature with an employer.

The term role for the purpose of this invention means a designation in which a person works for an employer.

The term jobseeker for the purpose of this invention means a person willing to take a job either in present or in future.

The term employer for the purpose of this invention means a person or a legal entity being represented by a person willing to employ a jobseeker in present or in future.

The term interface for the purpose of this invention means hardware and/or software enabling an operation on a computer system or a computer network.

The term module for the purpose of this invention means program code that enables a computer system to implement the actions described in conjunction therewith using any solution.

The term profile for the purpose of this invention means data or a set of data providing information of a jobseeker.

The term industry for the purpose of this invention may depend upon the nature of goods and services provided by plurality of business considered to be under the industry.

The term non-descriptive for the purpose of this invention means not capable of being interpreted in more than one manner and which are definite and identifiable in nature.

The term ‘pre-defined’ with respect to a question or a questionnaire means that a particular question or a questionnaire is defined at an instant prior to the instant of using the question or a questionnaire by the system or a user of the system.

FIG. 1 is a flowchart (100) representing an example of one of the embodiments of the invention, wherein the process by which a jobseeker uses the system of the invention is shown, wherein jobseeker provides attributes such current and past work details using a dashboard or graphical user interface for a profile in step 101 and wherein the system retrieves related domains & questions for provided job role or job posting from questionnaire database in step 102, and wherein jobseeker answers the questions of the predefined questionnaire and submits for matching using submission interface and matching interface respectively in step 103, and wherein matching interface filter current job openings based on jobseeker profile, do deep analysis and generate compatibility score w.r.t. job openings or job postings in step 104, and wherein jobseeker can see matching job openings with score, filter and apply for it using score generation interface, ranking interface and report generation interface.

FIG. 2 (200) is a flowchart representing an example of one of the embodiments of the invention, wherein the process by which an employer uses the system of the invention is shown, wherein employer creates job opening & provides role or designation using a dashboard in step 201, wherein the system retrieves related domains & questions for provided job role from attribute database and questionnaire database in step 202, and wherein the employer provides selection criteria & answers the questions with importance & submit for matching using submission interface and matching interface respectively in step 203, and wherein the matching interface filter jobseekers based on job opening criteria, do deep analysis and generate compatibility score w.r.t jobseekers using score generation interface, ranking interface and report generation interface in step 204, and wherein employer can see matching jobseekers with score, filter and contact for interview in step 205.

FIG. 3 is a system diagram (300) representing an example of one of the embodiments of the invention, wherein the interaction of jobseeker system 301 and employer system 303 with the matching interface 302 is shown, wherein the matching interface comprises of

### Filtering Module;

### Matching Module;

### Index Module; and

### Search Module.

FIG. 4 is a diagrammatic representation of an example of one of the embodiments of the invention, wherein the exemplary view of the graphical user interface of the system (400) is shown, whereby the tabs 401, 402, 403, 404 are used to switch between the different web pages of interfaces of the system, and wherein the tab 416 is used to interact with the authentication interface, and wherein different attributes 408, 409, 410, 411, 412 of the profile comprise of different attribute categories 407, and wherein additional interface 413, 414, and 415 can be included in the system for making it interactive and user friendly.

In an embodiment of the invention, the systems and methods can be practised using any electronic device. An electronic device for the purpose of this invention is selected from any device capable of processing or representing data to a user and providing access to a network or any system similar to the interne, wherein the electronic device may be selected from but not limited to, personal computers, mobile phones, laptops, palmtops, portable media players and personal digital assistants.

In an embodiment of the invention, the systems and methods of the present invention may be enabled through a computer program product which may be embodied in a computer.

In an embodiment of the invention, one or more user can be blocked or denied access or be required to reattempt access, to one or more of the aspects of the invention.

In an embodiment of the invention, a user may have a system to record or send alert or be informed in case any other user is accessing the user's restricted access virtual area.

In an embodiment of the invention, the systems and methods of the invention may simultaneously involve more than one user or more than one data storage device or more than one host server or any combination thereof

In an embodiment of the invention, certain additional systems and methods may be used along with the present invention to prevent or restrict hacking or related phenomenon such as but not limited to phishing, man in the middle attack, inside jobs, rogue access points, back door access, use of viruses and worms, use of trojans, denial of service attack, sniffing, spoofing, ransom ware or any combination thereof.

In an embodiment of the invention, a user may enter or communicate data or request through any suitable input device or input mechanism such as but not limited to a keyboard, a mouse, a joystick, a touchpad, a virtual keyboard, a virtual data entry user interface, a virtual dial pad, a software or a program, a scanner, a remote device, a microphone, a webcam, a camera, a fingerprint scanner, pointing stick.

In an embodiment of the invention, the systems and methods of the present invention provides or enables a user interface which may allow commands for a command line interface or a graphical user interface (GUI) enabling a user to create, modify and delete data or metadata or program or logic or algorithm or parameters associated with encryption method or encryption program or encryption language.

In an embodiment of the invention, the systems and methods can be practised using any electronic device which may be connected to one or more of other electronic device with wires or wirelessly which may use technologies such as but not limited to, Bluetooth, WiFi, Wimax. This will also extend to use of the aforesaid technologies to provide an authentication key or access key or electronic device based unique key or any combination thereof.

In an embodiment of the invention, the systems and methods can be practised using any electronic device which may contain or may be infected by one or more of an undesirable software such as but not limited to a virus, or a Trojan, or a worm, malware, spyware, adware, scareware, crimeware, rootkit or any combination thereof.

In an embodiment of the invention the system may involve software updates or software extensions or additional software applications.

In an embodiment of the invention, any form of internet security such as but not limited to, a firewall or antivirus or antimalware or registry protection can be used by a user in the same or different electronic device either simultaneously or separately, along with the systems or methods of the present invention.

In an embodiment of the invention one or more user can be blocked or denied access to one or more of the aspects of the invention.

The described embodiments may be implemented as a system, method, apparatus or article of manufacture using standard programming or engineering techniques related to software, firmware, hardware, or any combination thereof. The described operations may be implemented as code maintained in a “computer readable medium”, where a processor may read and execute the code from the computer readable medium. A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fibre, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices. An “article of manufacture” comprises computer readable medium, hardware logic, or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

In an embodiment of the invention computer program code for carrying out operations or functions or logic or algorithms for aspects of the present invention may be written in any combination of one or more programming languages which are either already in use or may be developed in future, such as but not limited to Java, Smalltalk, C++, C, Foxpro, Basic, HTML, PHP, SQL, Javascript, COBOL, Extensible Markup Language (XML), Pascal, Python, Ruby, Visual Basic .NET, Visual C++, Visual C#.Net, Python: Delphi, VBA, Visual C++ .Net, Visual FoxPro, YAFL, XOTcI, XML, Wirth, Water, Visual DialogScript, VHDL, Verilog, UML, Turing, TRAC, TOM, Tempo, Tcl-Tk, T3X, Squeak, Specification, Snobol, Smalltalk, S-Lang, Sisal, Simula, SGML, SETL, Self, Scripting, Scheme, Sather, SAS, Ruby, RPG, Rigal, Rexx, Regular Expressions, Reflective, REBOL, Prototype-based, Proteus, Prolog, Prograph, Procedural, PowerBuilder, Postscript, POP-11, PL-SQL, Pliant, PL, Pike, Perl, Parallel, Oz, Open Source, Occam, Obliq, Object-Oriented, Objective-C, Objective Caml, Obfuscated, Oberon, Mumps, Multiparadigm, Modula-3, Modula-2, ML, Miva, Miranda, Mercury, MATLAB, Markup, m4, Lua, Logo, Logic-based, Lisp (351), Limbo, Leda, Language-OS Hybrids, Lagoona, LabVIEW, Interpreted, Interface, Intercal, Imperative, IDL, Id, ICI, HyperCard, HTMLScript, Haskell, Hardware Description, Goedel, Garbage Collected, Functional, Frontier, Fortran, Forth, Euphoria, Erlang, ElastiC, Eiffel, E, Dylan, DOS Batch, Directories, Declarative, Dataflow, Database, D, Curl, C-Sharp, Constraint, Concurrent, Component Pascal, Compiled, Comparison and Review, Cocoa, CobolScript, CLU, Clipper, Clean, Clarion, CHILL, Cecil, Caml, Blue, Bistro, Bigwig, BETA, Befunge, BASIC, Awk, Assembly, ASP, AppleScript, APL, Algol 88, Algol 60, Aleph, ADL, ABEL, ABC, or similar programming languages or any combination thereof.

In an embodiment, the data storage unit or data storage device is selected from a set of but not limited to USB flash drive (pen drive), memory card, optical data storage discs, hard disk drive, magnetic disk, magnetic tape data storage device, data server and molecular memory.

In an embodiment of the invention the term network means a system allowing interaction between two or more electronic devices, and includes any form of inter/intra enterprise environment such as the world wide web, Local Area Network (LAN), Wide Area Network (WAN), Storage Area Network (SAN) or any form of Intranet.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

The process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

While this description has disclosed certain specific embodiments and examples of the present invention for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

### Example 1

In an example of the invention, at least one predefined questionnaire comprising non-descriptive questions or multiple choice options whereby descriptive answers are eliminated is as follows:
a. Have you worked in a car manufacturing facility as Quality Control manager for more than four years for a petrol driven sedan car?
   i. Yes
   ii. No
b. What is your monthly manufacturing target?
c. How many percentage of your target you generally achieve?
d. What are the no. leaves taken during past 6 months of your current employment?

Question ‘a’ is related to a very specific job description and experience which is desired to be matched by the employer using the ‘hierarchy, specialization and expertise’ attributes of a jobseeker and desired job. Weightage is given based on all the attributes, and the option to answer the question is only in ‘Yes’ or ‘No’. If the answer is ‘Yes’, then the weightage and scoring may be considered for the other relevant questions.

Question ‘b’ is related to the ‘target’ attributes of a jobseeker and desired job. Weightage is given based on the targets achieved. Higher the number more is the weightage associated with the question.

Question ‘c’ is related to the ‘experience’ attributes of a jobseeker and desired job. Weightage is given based on the experience in overseas recruitment. If yes more is the weightage associated with the question and if no lesser is the weightage.

Question ‘d’ is related to the ‘leave’ attributes of a jobseeker and desired job. Weightage is given based on the number of leaves taken in current or previous job. Lower the number more is the weightage associated with the question.

As all the questions have a definitive answer where there is no scope of keyword mismatch and descriptive terms matching, the results matched will be relevant to the employer's requirement and the scoring and ranking engines shall further enable arranging the matched candidates in a pre-defined desired order.

### Example 2

In an example of the invention, at least one predefined questionnaire comprising non-descriptive questions or multiple choice options whereby descriptive answers are eliminated with the at least one predefined questionnaire having one or more questions associated with another question of at least one predefined questionnaire, has the following exemplary set of questions:

### For a Cricket Player as a Jobseeker

Q1>What type of player you are?

### >Bowler

### >Batsman

### >All Rounder

If jobseeker selects a bowler then the next question shall be:
Q2>What type of bowling you do?

### >Fast

### >Medium

### >Spinner

If jobseeker selects a batsman then the next question shall be:
Q3>What is your average batting score?

### Example 3

In an example of the invention a tabular format of role hierarchy and specialization is provided below:

| Role Hierarchy | | | |
|---|---|---|---|
| Level 1 | Level 2 | Level 3 | Specializations |
| Information | | | |
| Technology | | | |
| | Business Analyst | | |
| | User Experience | | |
| | Programming | | |
| | Datawarehouse | | |
| | Production Support | | |
| | Content | | |
| | Management | | |
| | Quality Assurance | | |
| | | Manual Test Engineer | Web Applications, Mobile Applications, |
| | | | Desktop Applications, Mainframe |
| | | | Applications, ETL Applications, |
| | | | Webservices/Back End Applications |
| | | Sr. Manual Test | |
| | | Engineer | |
| | | Manual Test Lead | |
| | | Automation Test | HP QTP, IBM Rational Functional Tester, |
| | | Engineer | Silk Test, Selenium, Visual Studio Test |
| | | | Profressional, Telerik Test Studio |
| | | Sr. Automation Test | |
| | | Engineer | |
| | | Automation Test Lead | |
| | Infrastructure Team | | |

I claim:

1. A system for facilitation of recruitment or hiring on an online interface, wherein the system comprises:
a. at least one profile database capable of comprising at least one jobseeker profile, wherein the at least one jobseeker profile comprises of at least one Jobseeker's attribute;
b. at least one profile creation interface;
c. at least one employer request interface capable of allowing an employer to submit a request of at least one employer's desired job attribute;
d. at least one questionnaire database;
e. at least one matching interface;
f. at least one score generation or ranking interface;
g. at least one report generation interface capable of a generating a job match report; and
h. at least one graphical user interface capable of being accessed by a jobseeker or an employer;
wherein the at least one questionnaire database comprises at least one predefined questionnaire comprising non-descriptive questions or multiple choice options whereby descriptive answers are eliminated; and
wherein a jobseeker is capable of creating a profile using at least one profile creation interface, with profile attributes by providing answers to non-descriptive questions or multiple choice options of the at least one predefined questionnaire, whereby the profile is stored in the at least one profile database; and
wherein an employer is capable of identifying or searching a desired jobseeker by submitting a request of at least one employer's desired job attribute on the at least one employer request interface; and
wherein at least one matching interface is capable of matching at least one Jobseeker's attribute and at least one employer's desired job attribute;
wherein the at least one score generation or ranking interface generates a score or a rank or a combination of both score and rank based on a predefined algorithm, wherein the predefined algorithm uses a weightage provided to Jobseeker's attribute which has been matched by the at least one matching interface; and
and wherein the at least one report generation interface generates the job match report based on the score or the rank or the combination of both score and rank generated by the at least one score generation or ranking interface.

2. The system for facilitation of recruitment or hiring on an online interface of claim 1, the system further comprising at least one authentication interface capable of authenticating a jobseeker or an employer.

3. The system for facilitation of recruitment or hiring on an online interface of claim 1, system further comprising at least one job posting creation interface using which an employer may create a job posting which is stored in at least one job posting database.

4. The system for facilitation of recruitment or hiring on an online interface of claim 1, wherein the Jobseeker's attribute is selected from a set of role hierarchy, a specialization and a specific attribute and any combination thereof, wherein a specific attribute is selected from a set of age, sex, date of birth, location, educational qualification, years of experience, languages know, computer programs known, salary, father's occupation, mother's occupation, brother's occupation, sister's occupation, current employer, previous employer, percentage of marks, name of educational institution, extracurricular interest, passport validation details, PAN card validation details, identity card details, recommendation details, recommender's details, job title, VISA details, health status details and a combination thereof.

5. The system for facilitation of recruitment or hiring on an online interface of claim 1, wherein the at least one predefined questionnaire comprising non-descriptive questions or multiple choice options has one or more questions associated with another question of at least one predefined questionnaire such that if one question is answered with a specific answer than another question shall be asked based on the answer of the previous question.

6. A computer network implemented method for facilitation of recruitment or hiring on an online interface, wherein the method comprises the steps of:
a. storing a predefined questionnaire comprising non-descriptive questions or multiple choice options in at least one questionnaire database;
b. creating a profile with profile attributes by a jobseeker using at least one profile creation interface, with profile attributes by providing answers to non-descriptive questions or multiple choice options of the at least one predefined questionnaire;
c. storing the profile in at least one profile database;
d. submitting a request of at least one employer's desired job attribute on the at least one employer request interface for identifying or searching a desired jobseeker by an employer;
e. matching at least one Jobseeker's attribute and at least one employer's desired job attribute by at least one matching interface;
f. generating a score or a rank or a combination of both score and rank based on a predefined algorithm by at least one score generation or ranking interface, wherein the predefined algorithm uses a weightage provided to Jobseeker's attribute which has been matched by the at least one matching interface; and
g. generating a job match report by at least one report generation interface based on the score or the rank or the combination of both score and rank generated by the at least one score generation or ranking interface.

7. A method by which a jobseeker finds matching jobs and similar jobseekers using a system as claimed in claim 1, the method comprising the steps of:
a. signing up or logging into a website or a job portal;
b. redirecting to a dashboard, wherein the jobseeker can edit a profile or attributes related to the profile;
c. submitting the edited profile or the attributes for the process of matching; and
d. viewing matching jobs and similar jobseekers along with a score.

8. A method by which an employer finds matching jobseekers a system as claimed in claim 1, the method comprising the steps of:
a. signing up or logging into a website or a job portal;
b. redirecting to a dashboard, wherein the employer can edit a job post or attributes in the job post;
c. submitting the edited post or attributes for the process of matching;
d. viewing matching jobseekers along with a score; and
e. editing the post or changing the attributes to filter the results obtained in the previous step.

9. The method for facilitation of recruitment or hiring on an online interface of claim 6, further comprising the step of authenticating a jobseeker or an employer by at least one authentication interface.

10. The method for facilitation of recruitment or hiring on an online interface of claim 6, further comprising the step of creating a job posting which is stored in at least one job posting database, wherein said step of creating is done by at least one job posting creation interface.

11. The method for facilitation of recruitment or hiring on an online interface of claim 6, wherein the Jobseeker's attribute is selected from a set of role hierarchy, a specialization and a specific attribute and any combination thereof, wherein a specific attribute is selected from a set of age, sex, date of birth, location, educational qualification, years of experience, languages know, computer programs known, salary, father's occupation, mother's occupation, brother's occupation, sister's occupation, current employer, previous employer, percentage of marks, name of educational institution, extracurricular interest, passport validation details, PAN card validation details, identity card details, recommendation details, recommender's details, job title, VISA details, health status details and a combination thereof.

12. A computer program product for facilitation of recruitment or hiring on an online interface, the computer program product embodied in a computer readable medium that, when executing on a computer, performs steps comprising:
a. storing a predefined questionnaire comprising non-descriptive questions or multiple choice options in at least one questionnaire database;
b. creating a profile with profile attributes by a jobseeker using at least one profile creation interface, with profile attributes by providing answers to non-descriptive questions or multiple choice options of the at least one predefined questionnaire;
c. storing the profile in at least one profile database;
d. submitting a request of at least one employer's desired job attribute on the at least one employer request interface for identifying or searching a desired jobseeker by an employer;
e. matching at least one Jobseeker's attribute and at least one employer's desired job attribute by at least one matching interface;
f. generating a score or a rank or a combination of both score and rank based on a predefined algorithm by at least one score generation or ranking interface, wherein the predefined algorithm uses a weightage provided to Jobseeker's attribute which has been matched by the at least one matching interface; and
g. generating a job match report by at least one report generation interface based on the score or the rank or the combination of both score and rank generated by the at least one score generation or ranking interface.
